(19) United States
(12) Patent Application Publication
(10) Pub. No.: US 2006/0080722 A1
(43) Pub. Date: Apr. 13, 2006

(54) Buffered waveforms for high speed digital to analog conversion

(76) Inventor: John Santhoff, Carlsbad, CA (US)

Correspondence Address: PULSE-LINK, INC., 1969 KELLOGG AVENUE, CARLSBAD, CA, 92008, US

(21) Appl. No.: 11/188,231

(22) Filed: Jul. 21, 2005

Related U.S. Application Data
(60) Provisional application No. 60/617,769, filed on Oct. 12, 2004.

(51) Int. Cl. H04N 7/173; H04N 7/16

(52) U.S. Cl. 725/116; 725/114; 725/100; 725/131; 725/144; 725/146

(57) ABSTRACT

Apparatus' and methods of supplying digital data to a digital-to-analog coverter (DAC) without using a conventional digital signal processor are provided. The present invention may provide pre-digitized communication waveforms to a DAC according to any desired communication requirement. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

Priority is claimed to U.S. provisional application Ser. No. 60/617,769, filed Oct. 12, 2004, titled: Programmable Communications Transceiver, which is referred to and incorporated herein in its entirety by this reference.

### FIELD OF THE INVENTION

The present invention generally relates to communications. More particularly, the invention concerns a method for digitally synthesizing communications signals.

### BACKGROUND OF THE INVENTION

The Information Age is upon us. Access to vast quantities of information through a variety of different communication systems are changing the way people work, entertain themselves, and communicate with each other. For example, as a result of increased telecommunications competition mapped out by Congress in the 1996 Telecommunications Reform Act, traditional cable television program providers have evolved into full-service providers of advanced video, voice and data services for homes and businesses. A number of competing cable companies now offer cable systems that deliver all of the just-described services via a single broadband network.

Bandwidth, a measure of the capacity of a communications medium to transmit and receive data, has become increasingly important with the continuing growth in data transmission demands. Applications such as in-home movies-on-demand; video teleconferencing, and interactive video in homes and offices require high data transmission rates.

Cable television networks, such as multiple service operators (MSOs), generally employ coaxial cables coupled to optical fiber systems to transmit and receive data. Conventional approaches for transmitting communication signals through a medium such as cable entail modulating the communication signal at a frequency that lies within the electrically conductive range of the medium. Many costly and complicated schemes have been developed to increase the bandwidth in conventional conductive wire and/or cable systems. Some of these schemes use sophisticated switching or signal time-sharing arrangements. Each of these methods is costly and complex.

Current cable television “head-end” architectures require a significant amount of hardware. Efficiency may be compromised because of the relatively rigid, and limited, nature of the system hardware elements in use, particularly at the head-end of the cable television system where channel content is received from satellite “antenna farms” and other sources. The architecture at the cable television head-end generally comprises multiple racks of components, many of which have a limited capability, such as dedicated analog NTSC receivers, or receivers for QAM 64/256 modulated signals. These received signals are routed to a combiner, a device that combines the separate channel signals into a single composite signal.

The resulting composite television signal is routed to a fiber optic modulator for transmission onto optical fiber for distribution into the field. Enhancements and upgrades to the channel modulators and combiner are costly because such actions often involve physical removal and replacement of these hardware components with more expensive units causing undesirable periods of system, or channel unavailability to the consumer. Moreover, these hardware components require relatively substantial amounts of power and physical space.

Another deficiency in current cable television systems lies in the limited ability of the cable service provider to timely locate and replace failed, or failing, components or monitor and verify system functionality at remote locations “downstream” from the head-end. Such components include, for example, fiber optic transceivers for re-introducing the cable television composite signal from the optical fiber to local coaxial cable, and field amplifiers for boosting the signal strength at various points in the cable television network. Current procedures call for a technician to perform periodic preventive maintenance that optimizes system performance and mitigates the likelihood of component failure, requiring the technician to travel to the site of each component to physically inspect, test, and replace it as necessary. Though costly and time-consuming, scheduled component inspections and replacements are still more desirable than recovering from system outages and the resulting customer ire.

Therefore, there remains a need to overcome one or more of the limitations in the above-described, existing art.

### BRIEF DESCRIPTION OF THE DRAWINGS

Various embodiments of the present invention taught herein are illustrated by way of example, and not by way of limitation, in the figures of the accompanying drawings, in which:

FIG. 1 is an illustration of a conventional cable, or hybrid fiber-coax communication system topology including a head-end;

FIG. 2 is an illustration of signal processing generally performed at the head-end of a conventional cable, or hybrid fiber-coax communication system as shown in FIG. 1;

FIG. 3 is an illustration of one embodiment of the present invention comprising high-speed analog-to-digital (ADC) and digital-to-analog (DAC) components;

FIG. 4 is an illustration of one embodiment of the present invention comprising a main processing module utilizing one or more processing units for digital signal synthesis;

FIG. 5 is an illustration of one embodiment of a processing unit for digital signal synthesis based on digital signal processing components;

FIG. 6 is an illustration of one embodiment of a digital signal synthesis processing unit employing a buffered waveform look-up table;

FIG. 7 is an illustration of another embodiment of a digital signal synthesis processing unit employing multiple buffered waveform look-up tables;

FIG. 8 is an illustration of different communication methods;

FIG. 9 is an illustration of two ultra-wideband pulses;

FIG. 10 is an illustration of one embodiment of the present invention wherein ultra-wideband (UWB) communication signals are injected into a cable, or hybrid fiber-coax TV channel spectrum;

FIG. 11 is an illustration of a status request and response message protocol process flow;

FIG. 12 is an illustration of an autonomous status response message protocol process flow;

FIG. 13 is an illustration of one embodiment of the present invention in which in-device sensors provide system performance measurement information to the cable, or hybrid fiber-coax head-end;

FIG. 14 is an illustration of optimal partitioning of power levels between conventional cable channel content and UWB content;

FIG. 15 is an illustration of general functions of UWB system components in one embodiment of the present invention; and

FIG. 16 is an illustration of current Federal Communication Commission mandated emission limits for UWB devices in the United States.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE INVENTION

In the following paragraphs, the present invention will be described in detail by way of example with reference to the attached drawings. While this invention is capable of embodiment in many different forms, there is shown in the drawings and will herein be described in detail specific embodiments, with the understanding that the present disclosure is to be considered as an example of the principles of the invention and not intended to limit the invention to the specific embodiments shown and described. That is, throughout this description, the embodiments and examples shown should be considered as exemplars, rather than as limitations on the present invention. Descriptions of well known components, methods and/or processing techniques are omitted so as to not unnecessarily obscure the invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

In general, one embodiment of the present invention provides a method of supplying digital data to a digital-to-analog coverter (DAC) without using a conventional digital signal processor. The present invention may provide pre-digitized communication waveforms to a DAC according to any desired communication requirement.

One embodiment of the present invention may provide one or more tables containing a plurality of digitized waveforms. These digitized waveforms are mapped to desired communication symbols. For example, when the DAC is transmitting radio frequency energy as part of a wireless communication system, the stored waveforms may comprise waveforms modulated in accordance with the IEEE 802.11 standard, or the BLUETOOTH standard, or with an ultra-wideband technology communication standard.

Generally, a traditional cable television provider, a community antenna television provider, a community access television provider, a cable television provider, a hybrid fiber-coax television provider, an Internet service provider, an IPTV provider or any other provider of television, audio, voice and/or Internet data generally receives broadcast signals at a central station, either from terrestrial cables, over-the-air broadcast, and/or from one or more antennas that receive signals from communications satellite(s). The broadcast signals are processed, combined, and then distributed, usually by coaxial and/or fiber-optic cable, from the central station to nodes located in business or residential areas.

As can be inferred from the above list, cable television networks are currently deployed using several different topologies and configurations. The most common configurations found today include coaxial cable and Hybrid Fiber-Coax Systems (HFCS) that employ both fiber optic and coaxial cables. These systems may employ both analog and digital signals. Systems that employ only analog signals are further characterized by their use of established NTSC/PAL (National Television Standards Committee/Phase Alternation Line) modulation, with requires use of frequency carriers at 6 or 8 MHz intervals.

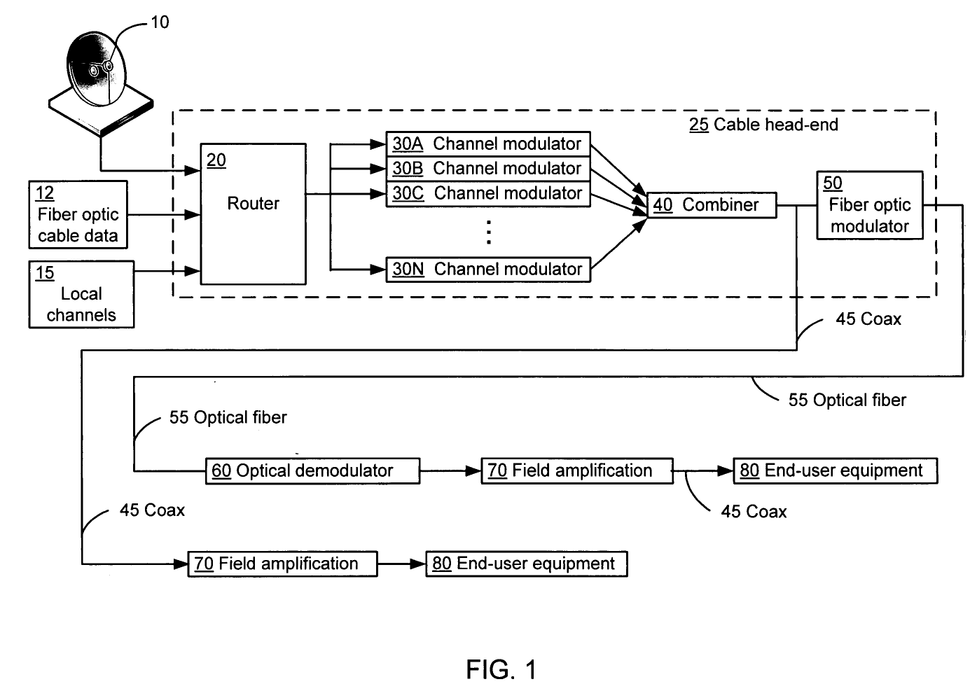

With reference to FIG. 1, a conventional hybrid fiber-coax system (HFCS), or network, is illustrated. It will be appreciated that the HFCS network may be part of a multiple service operator system, and that specific architecture components may vary, from network to network. The HFCS employs a combination analog-digital topology, as both coaxial 45 (analog), and fiber optic 55 (digital) media are used. According to the frequency allocations specified by the ANSI/EIA-542-1997 standard that usually arranges the analog channels from 2 to 78, each modulated in 6 MHz allocations, using frequencies from 55 to 547 MHz. When using HFCS, digital channels typically start at channel 79 and go to 136 and occupy a frequency range from 553 to 865 MHz. In some extended HFCS systems, channel assignments can go as high as channel 158 or 997 MHz. 1 gigahertz is currently the upper frequency limit, as network components, such as amplifiers and TV tuners are incapable of operation above that frequency. The current ANSI/EIA-542-1997 standard only defines and assigns channels to 997 MHz. However, the actual wire or cable media is generally capable of carrying frequencies up to 3 GHz and beyond.

In both analog cable and HFCS systems, a satellite downlink containing video, audio, Internet, and/or other data is received at antenna 10, and enters the cable company's “head-end” 25 at the router 20, shown in FIG. 1. Additional video and/or other data streams 15 (non-satellite received), including data received by fiber optic cable 12 may feed data to the router 20. Individual video and other data streams (either NTSC, MPEG, or any other employed protocol) are extracted from the satellite downlink stream or other data streams 15 and routed to channel modulators 30A-N, each specific to an individual television channel. Alternatively, the radio frequency (RF) content received from the satellite antenna 10 and other data streams 15 are presented substantially directly to the channel modulators 30. In both cases, an initial task performed by each channel modulator 30 is to reject frequency content from the input broadband RF signal that is extraneous to the particular output cable channel assigned to the specific channel modulator 30. After input channel filtering, the received channel content is converted from the input channel carrier frequency to the carrier frequency of the output cable channel. The outputs from each channel modulator 30 are then sent to combiner 40 and combined into one broadband RF signal. From this point the composite, broadband RF signal containing the combined channels is amplified and sent, either by coaxial cable 45 or fiber optic 55 cable, to cable television customers. The broadband RF signal may be amplified by field amplifiers 70, and ultimately received by the customers, or other end-users equipment 80, such as a set-top box, or other device.

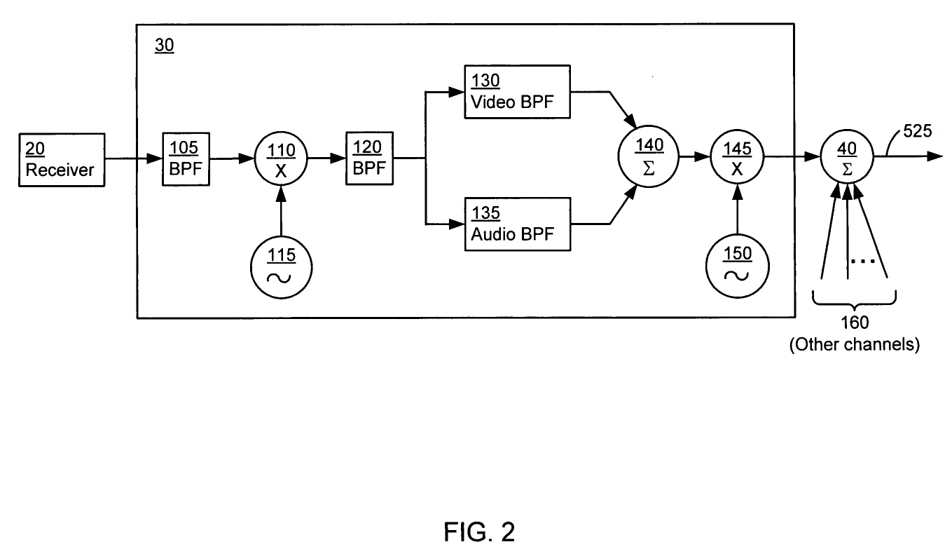

Referring now to FIG. 2, some components of the cable head-end 25, as shown in FIG. 1, are illustrated. Generally, the head-end 25 includes one or more routers 20, channel modulators 30, and combiners 40, and in HFCS, a fiber optic modulator 50. It will be appreciated that the cable head-end 25 may include other components as well. The router 20 forwards the data stream, that may comprise both, or one of, the satellite downlink stream or the other data streams 15 to a band-pass filter (BPF) 105. BPF 105 is structured to reject frequency content not pertaining to the output cable channel assigned to the specific channel modulator 30. The specific channel signal is then mixed with a carrier, which is generated by a local oscillator (LO) 115, which mixes the specific channel signal to an intermediate frequency (IF) by mixer 110. This mixing step converts the channel signal to a signal at the IF frequency. This step is commonly performed in television signal processing to allow a single circuit design to accommodate many different input and output channel frequencies. By converting a channel signal at an arbitrary input channel frequency to a standard IF, subsequent processing may be performed with circuitry designed to operate at IF instead of at a multiplicity of possible channel frequencies.

Referring again to FIG. 2, the channel signal, once converted to IF, is then passed through a secondary BPF 120 to remove extraneous signal energy outside of the IF band. For North American (i.e., NTSC) implementations, the IF is typically between 41 and 47 MHz. In this example, the picture, or video and sound, or audio carriers are then separated. The picture signal occupies the spectrum from about 41.75 to 46.5 MHz, and the audio rides on a 41.25 MHz carrier. Accordingly, the signal is supplied a video BPF 130, and an audio BPF 135. The video BPF 130 filters the picture signal of audio content and the audio BPF 135 filters the audio signal of picture content. The two filtered signal streams are then recombined at combiner 140 into a single signal, centered at IF. A secondary local oscillator (LO) 150 generates a carrier signal and secondary mixer 145 multiplies the combined signal by the carrier signal. Secondary mixer 145 places the signal content at the desired frequency for transmission. The output of channel modulator 30 is then combined with similar outputs from other channel modulators by combiner 40 to produce the composite signal 525.

The routers 20, channel modulators 30, and combiners 40 used in a cable television head-end 25 are typically discrete hardware components employing mostly analog circuitry. It will be appreciated that in some instances, analog components may have higher power requirements than their digital counterparts. Further, each channel modulator 30 modulates a single channel and, therefore, literally hundreds of channel modulators 30 are required in every cable head-end 25 to accommodate the hundreds of channels available on most cable television networks. Moreover, a considerable amount of physical space is required to house rows upon rows of racks containing the channel modulators and associated components. The cable head-end 25 represents a substantial investment for cable operators.

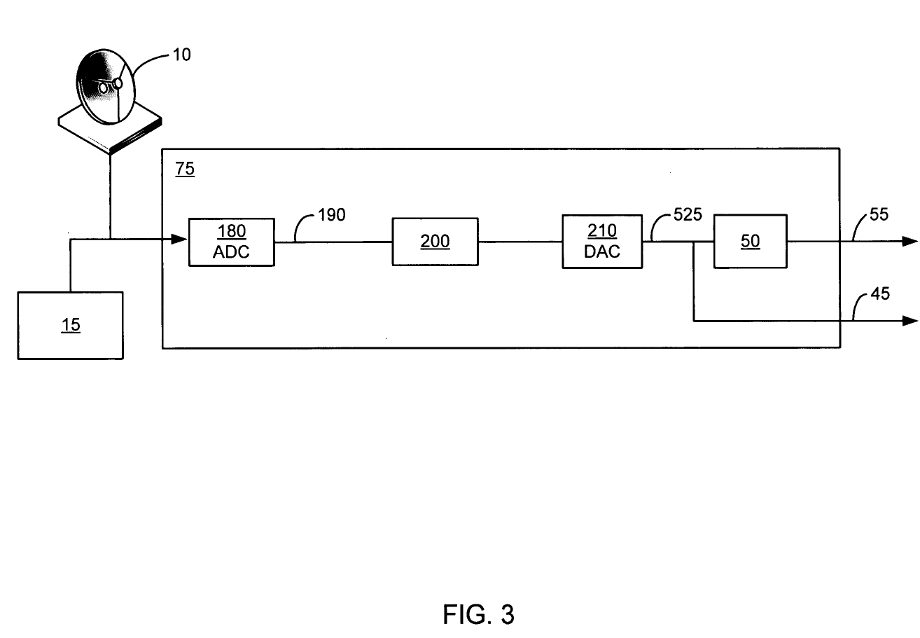

Referring now to FIG. 3, which illustrates a software-definable head-end (SDHE) 75, constructed according to one embodiment of the present invention. One application of the SDHE 75 allows for the replacement of the multiple channel modulators 30A-N and combiner 40. One feature of the SDHE 75 is that it performs direct digital synthesis of a signal that is equivalent to the composite signal 525 present at the output of the RF combiner 40. That is, the SDHE 75 provides direct digital synthesis of the composite, broadband output cable television signal. As shown in FIG. 3, in one embodiment, a high-speed analog-to-digital converter (ADC) 180 receives analog content from satellite antennas 10 and/or other data streams 15. The content from the satellite antennas 10 may be pre-processed prior to employing the present invention. Additional content may be provided from any number of other sources. One feature of present invention is that the ADC 180 will have the capacity to adequately “over sample” the analog input signals. This is because Nyquist sampling theory holds that the minimum sampling frequency at which a signal may be accurately resolved is twice the highest frequency content of the signal. In alternative embodiments, to provide more robust frequency resolution, “4-times over sampling” may be employed.

The digital data, either from digital sources or following conversion by analog to digital converter 180, the resulting digital data stream 190 comprising sampled content is passed to a programmable digital processing module 200. The digital processing module 200 may perform tasks such as channel separation, filtering, input-to-output channel conversion, and channel recombination. The output of digital processing module 200 comprises a sampled version of the combined broadband signal containing the input cable channels now reassigned to cable television channels. Moreover, the digital data stream generated by the processing module 200 represents a digitized equivalent of the composite signal 525 produced by the combiner 40 shown in FIG. 1. As shown in FIG. 3, the sampled composite signal is passed to a high-speed DAC 210 for conversion, resulting in the composite signal 525. The composite signal is passed from the DAC 210 to a coax cable 45 and/or a fiber optic modulator 50 before distribution over a fiber optic cable 55.

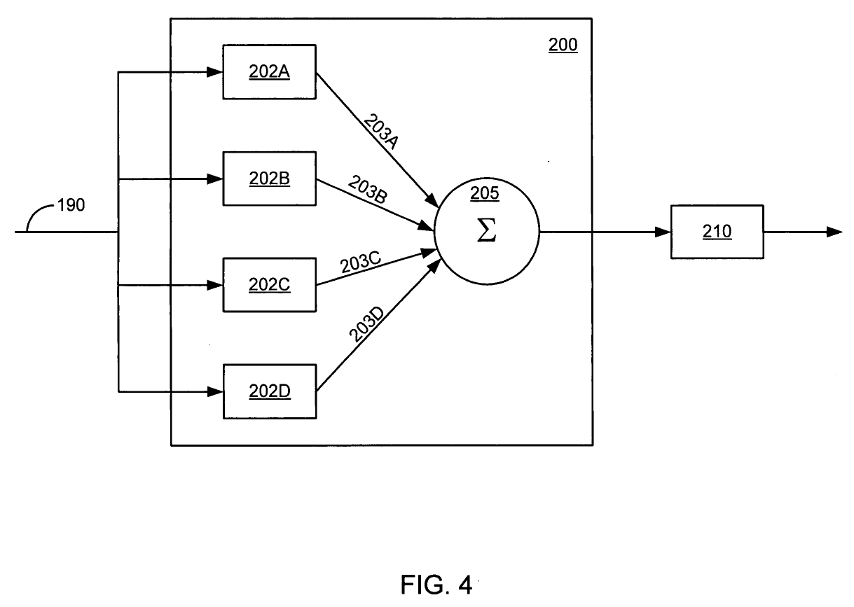

As shown in FIG. 4, one embodiment of the digital processing module 200 is illustrated. The incoming digital data stream 190 to passed to one or more processing units 202A-D. It will be appreciated that though FIG. 4 depicts this embodiment of the invention as employing four processing units 202A-D, the invention is not limited to this number of processing units 202. The output of each processing unit 202 may comprise one or more input signals received over the digital data stream 190, each modulated to an output cable channel carrier according to the input-to-output channel mapping employed by a specific cable service provider. The output 203A-D of each processing unit 202A-D is passed to a digital combiner 205 that sums the outputs in a similar manner to the combiner 40, shown in FIG. 1. The output of digital combiner 205 is a sampled composite broadband cable signal that is passed to the high-speed DAC 210. The DAC 210 converts the sampled broadband signal into its analog equivalent, representing a digitally synthesized equivalent of the broadband signal that is generated at the output of an analog combiner 40, shown in FIG. 1. One feature of the SDHE 75 is that the cost, complexity and power consumption of the head-end 25 is reduced by replacing functionality formerly carried out by numerous analog components with a single re-programmable digital apparatus. This greatly reduces the cost of a head-end 25.

One feature of the present invention is that the software, or logic installed on digital processing units 202 may be modified, or replaced after initial installation. Substantial functional flexibility is thereby provided since any new computational requirements demanded of the processing units 202 can be implemented without costly modification or replacement of hardware. Thus, capabilities to manage new and different video, audio, and data formats, including high definition television (HDTV), and to redefine channel assignments and carrier frequencies are easily implemented. As video compression and decompression methods continually improve and evolve, these new methods can be implemented at the cable head-end 25 by simply reprogramming the appropriate processing units 202. It is further contemplated that re-programming of the processing units 202 may occur at any time, including during the installation process, “on-the-fly” (while the system is in operation), when required to handle transient or periodic processing tasks, and when the head-end 25 may be shut down for maintenance. In one embodiment of the invention, the processing units 202 may further act as real-time control mechanisms to maintain various signal transmission parameters within desired tolerances. Cable television channel signal transmission power may be controlled, for example, to maintain frequency assignment, carrier to noise ratios, and other parameters at optimal levels according to feedback information from intermediate cable network devices such as amplifiers, splitters, and fiber optic receivers, and end-user devices such as set-top-boxes, and wireless devices that may be fed from the set-top-boxes.

It is anticipated that these wireless devices may include Wireless Personal Area Network (WPAN) devices, such as BLUETOOTH devices or WPAN ultra-wideband devices, Wireless Local Area Devices (WLAN), such as WI-FI devices or WLAN ultra-wideband devices, and Wireless Metropolitan Area Network (WMAN) devices such as WI-MAX devices. (BLUETOOTH is a registered trademark of Bluetooth SIG, Inc. of Delaware) Another embodiment of the invention contemplates that each of the processing units 202, shown in FIG. 4, may comprise a specialized microprocessor dedicated to digital signal processing, known as a “digital signal processor” (DSP). The DSP may be reprogrammable through a variety of methods after installation and during operation. For this embodiment of the invention, the tasks for the DSP may include modulating the input digital waveforms to one or more specific channel frequencies. Other tasks may include decompressing certain data prior to processing, such as video that may have been compressed using MPEG-2, MPEG-4, JPEG 2000, or other compression methods, or converting data from one storage or transmission format to another. Real-time control of various channel signal transmission parameters can be realized, for example, by structuring the DSP to read parametric values from memory. Signal power, amplitude, and filtering characteristics can thus be updated as needed by providing a separate control process to copy new parameters to appropriate memory locations where they are read and subsequently implemented by the DSP. As shown in FIG. 4, the digitized streams from the processing units 202 employing a DSP are routed to combiner 205, and the resulting composite signal is passed to the high-speed DAC 210.

In another embodiment of the invention, each processing unit 202 may comprise one or more field programmable gate arrays (FPGA). A FPGA is a logic device that is generally reprogrammable after manufacture. There are many varieties of FPGA, several of which possess the capability to be reprogrammed while in-system (i.e., installed with new/modified software). These include, for example, those based on static random access memory (SRAM), electrically erasable programmable read-only memory (EEPROM), and flash-erase EPROM (FLASH) technology. In another embodiment of the present invention, each processing unit 202 comprises one or more dedicated state machines. Functional re-progammability is enabled for both FPGAs and dedicated state machines by writing new processing parameters to accessible memory.

Referring again to FIG. 4, one method of employing this aspect of the present invention is as follows. In this embodiment, the input signal 190 comprises a frequency-division-multiplexed signal. It will be appreciated that other types of signals may comprise the input signal 190. The bandwidth of a the digitized, frequency-division-multiplexed input signal 190 is distributed among a plurality of processing units 202 (four shown) comprising the programmable digital processing module 200. By way of example and not limitation, input signal 190 may have a bandwidth of approximately 1 GHz, partitioned among four processing units 202 as follows: 0-240 MHz to a first unit 202A, 240-480 MHz to a second unit 202B, 480-720 MHz to a third unit 202C, and 720-960 MHz to a fourth unit 202D. It is anticipated that partitioning may include the calculation of a Fast Fourier Transform output. For the purposes of this example the 1 GHz input signal was over-sampled at 4 GHz. It will be appreciated that other sampling methods, requiring less over-sampling, may be employed.

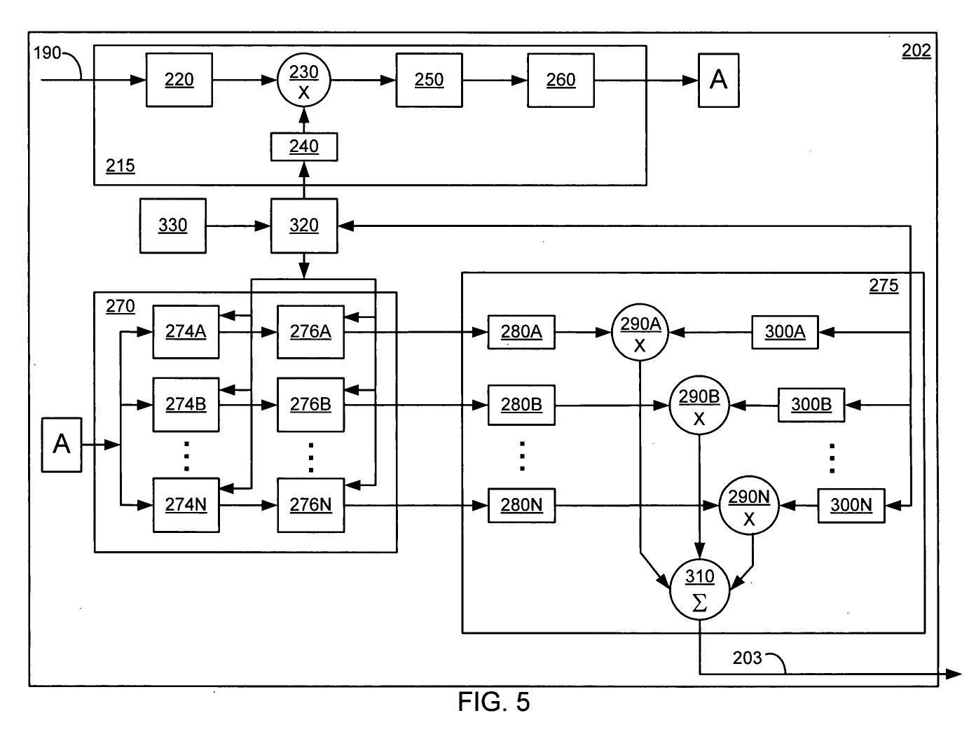

One embodiment of a processing unit 202 is illustrated in FIG. 5. This embodiment comprises an input stage 215, a DSP 270, and an output stage 275. It will be appreciated that the arrangement of these components may vary from the illustration, for example, the output stage 275 may be located on a different component than the processing unit 202. The input signal 190 is passed through a digital BPF 220 in the input stage 215. The digital BPF 220 is structured to reject frequencies outside of the assigned partition of the input bandwidth.

For example, in the frequency-partitioning arrangement described above, the second processing unit 202B rejects frequencies outside of the range from 240-480 MHz. The filtered signal is next received by digital mixer 230 that “down-converts” the signal to a base-band frequency range of 0-240 MHz. The digital mixer 230 accomplishes this down conversion by multiplying the filtered digital output sequence from the digital BPF 220 by a stored digital carrier sequence 235 at 240 MHz, creating copies of the signal at 0 Hz and at 480 MHz. The resulting signal is then passed through a low pass filter (LPF) 250 to reject frequency content above 240 MHz, leaving only the low frequency copy at base-band. The down-converted signal may now be decimated or “down-sampled” because it retains the 4 GHz sampling rate applied to the original 1 GHz signal. However, the 4 GHz sampling rate is no longer necessary to accurately resolve the frequency content of the filtered, 240-480 MHz partition, now down-converted to the 0-240 MHz range. Accordingly, the signal may then be down-sampled by decimator 260. The resulting digital signal is then passed from the input stage 215 to the DSP 270, thus completing input stage processing. It will be appreciated that one advantage gained by down-sampling lies in commensurately reducing the workload imposed on DSP 270, requiring it to process data at one-fourth of the rate from which the original signal arrived at the input stage 215 from ADC 180.

Shown in FIG. 5, the DSP 270 may be structured to perform many tasks with the digital data down-sampled, and received from, the input stage 215. These tasks may include, but are not limited to, separate picture and audio signal filtering, signal power adjustment, and data reformatting. Task flexibility may be effected, for instance, by storing digital filter tap weights in memory 320 to which a separate controller 330 may write updated weight values for access by the DSP 270. Real-time power adjustments can be made by structuring the separate controller 330 to write periodically updated signal power parameters to memory, which the DSP 270 can read and use.

In one embodiment, DSP 270 contains a bank of band-pass filters 274A-N, each of the bank of BPFs 274A-N is structured to reject frequency content outside the range of some single input channel frequency. In the present example, there would be forty 6 MHz channels residing in the 0-240 MHz base band signal passed to DSP 270. This would result in forty band-pass filters 274 each structured to pass one channel each. It will be appreciated that a BPF may be implemented digitally by a finite impulse response (FIR) filter, and that a FIR filter is defined essentially by the number filter taps it employs and filter weights assigned to the taps. One feature of the present invention is that the filter weights can be software-defined allowing for reconfiguration. This redefinition may be accomplished by controller 330 modifying sets of filter tap weights in a memory 320 accessed by any one of the bank of BPFs 274A-N. When directed, the controller 330 may copy new or updated filter tap weights to specific locations in memory 320 and may therefore effect configuration changes to any of the bank of BPFs 274A-N.

The output stage 275 of the processing unit 202 generates a combined signal 203 containing one or more channels. In the current example, there are forty input channels, received from a bank of forty processing blocks 276A-N. Each processing block 276A-N may perform one or more functions, such as signal filtering, signal amplitude adjustment, signal power adjustment, and data reformatting, among others. The output of each processing block 276A-N comprises a digital stream with a 6 MHz bandwidth representing the processed content of a single input cable channel.

One of the primary tasks performed at the cable head-end 25 is to convert content on each input cable channel to some output cable channel according to the input-to-output channel mapping employed by the cable service provider. The output stage 275 accomplishes this by first providing that each per-channel digital stream generated by the bank of processing blocks 276A-N is interpolated onto the frequency of the carrier by interpolators 280A-N. Each processed stream is then multiplied by discrete samples of the appropriate carrier by carrier mixers 290A-N. These discrete samples can be stored as digital carrier sequences 300A-N. Each discrete carrier sequence, which may be any one of carrier sequences 300A-N, may be accessed from memory 320 instead of being hard-coded or created by analog circuitry. At any time, the controller 330 may copy a digital carrier sequence representing a different channel up-conversion to the memory location in common memory 320 accessed by, for example, carrier mixer 290B. One feature of this embodiment is that the input-to-output channel mapping may be modified in real time, providing operational flexibility not made available by current analog systems.

Each processed stream is then multiplied by discrete samples of the appropriate carrier by carrier mixers 290A-N. Following up-conversion to the appropriate frequency band, a plurality of like-processed signals are combined by processing combiner 310. The overall result is an output 203 representing a frequency division multiplex of the output channel content provided by each of the processor units 202A-D. As shown in FIG. 4, the output 203 from all the processing units 202A-D are combined in digital combiner 205 and the resulting composite signal is passed to the high-speed DAC 210.

In another embodiment of the present invention, the processing units 202A-D may comprise one or more devices utilizing a list, or look-up-table (LUT) of buffered waveforms as an alternative to manipulating digital data received over the digital stream 190 from the ADC 180. One feature of this embodiment is that it reduces the computational complexity from calculating a waveform to matching and copying an output waveform from a storage location in memory. The LUT methods used in this embodiment of the invention are designed to allow DSP functions to keep up with very high speed ADC and DAC components.

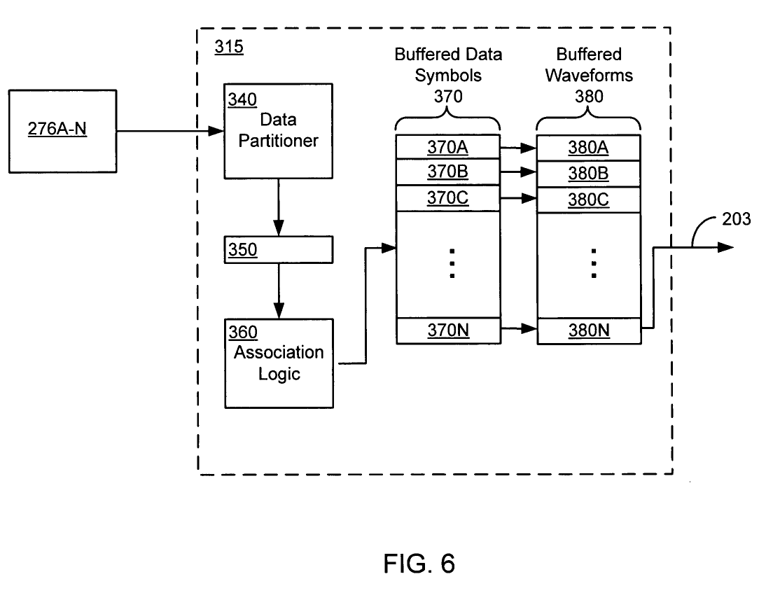

Referring to FIG. 6, an alternative embodiment output stage 275 is illustrated. Output from processors 276A-N is passed to buffered output stage 315. In one embodiment, one buffered output stage 315 may receive all the output from each processor 276A-N, or alternatively, one or more buffered output stages 315 may receive output from corresponding processors 276A-N. As illustrated in FIG. 6, output from the processors 276A-N may be routed to partitioner 340 to be divided into discrete blocks of data such as “words” or “symbols.” Generally, a symbol is something that represents something else. For example, a certain voltage level may be used to represent a “1” or a “0,” or an absence of a voltage may be used to represent a “1” or a “0.” It will be appreciated that any number of binary digits (0 or 1) may be represented by a symbol, and that the symbol itself may be a positive or a negative voltage, an absence of a voltage, or some other type of representation.

For example, a symbol output from partitioner 340 is written to a symbol register 350. Association logic 360 can then perform a matching association between the input symbol and a “dictionary” of data symbols 370A-N stored in a memory buffer. Waveform buffer 380 contains a collection of digitized waveforms 380A-N, where each waveform 380A-N is associated with a buffered data symbol 370A-N. Associating a buffered waveform to a buffered data symbol replaces the computation of a DSP-generated output waveform, as discussed above, in connection with FIG. 5. One feature of this aspect of the invention is the increased speed realized by obtaining a waveform from memory, rather than computing a waveform. Once a match between the input symbol and a buffered data symbol 370A-N is successfully accomplished, the stored digital waveform 380A-N corresponding to the buffered data symbol 370A-N is accessed and passed to output 203.

Alternatively, the data symbols may be partitioned in data partitioner 340 and then associated with one or more corresponding buffered waveforms obtained from the waveform buffer 380. In this embodiment, the symbol register 350 and association logic 360 are eliminated, or merged into the data partitioner 340.

The buffered digital waveforms are equivalent to sampled versions of analog waveforms modulated to contain the information provided by the input symbol. When transmitted onto a cable television network, or other type of network, this waveform conveys the information contained by the input symbol to end-user equipment 80, as seen in FIG. 1. Digital copies of modulated waveforms reside in waveform buffers 380A-N and are addressed, or “looked up,” in waveform buffers 380A-N according to the input symbol. Each digital copy of the modulated waveforms comprise a group of digital values. The digital values are copied from waveform buffers 380A-N and passed to output 203. As each new input symbol is presented to buffered output stage 315, an appropriate digitized waveform is matched and passed to output 203. The resulting output 203, which comprises content of one or more cable channels, is then passed to the digital combiner 205, where it is combined with the rest of the cable television channel content generated by the processing units 202A-D, as shown in FIG. 4. The combined signal is then passed to the high-speed DAC 210 which generates the RF cable television signal.

In one embodiment of the present invention, the buffered waveforms 380A-N may include waveforms from a number of different communication methods. For example, the buffered waveforms 380A-N may comprise discrete samples of an Orthogonal Frequency Division Multiplexed (OFDM) signals at different transmission frequencies. Alternatively, the buffered waveforms 380A-N may include discrete samples of a QAM modulated waveform at different transmission frequencies. It is anticipated that virtually any communications waveform may be generated by storing, and using the appropriate buffered waveforms 380A-N.

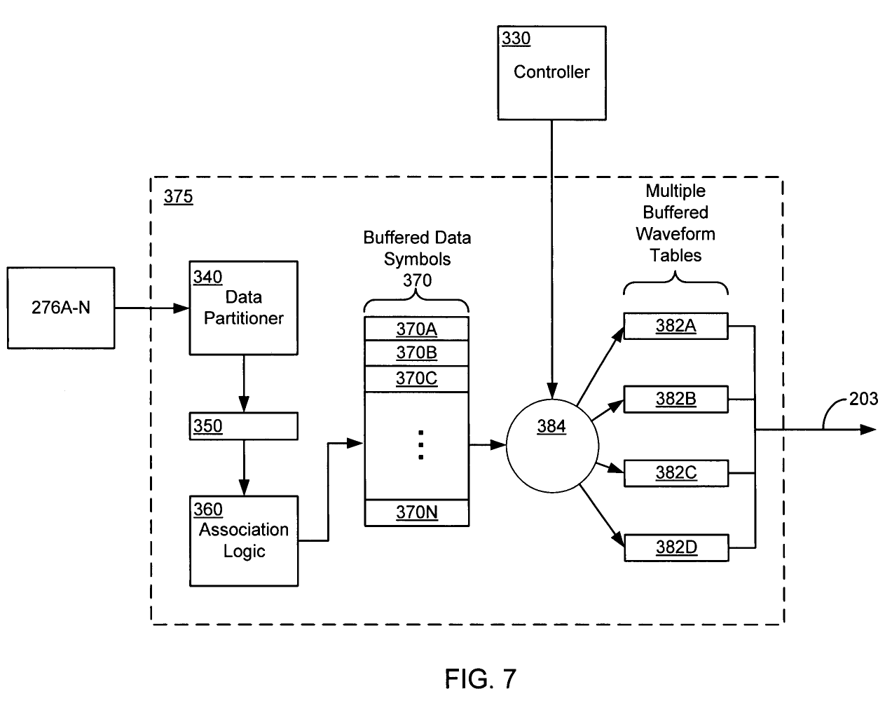

Another embodiment of the present invention is illustrated in FIG. 7, which illustrates a multiple-buffered output stage 375. This embodiment comprises multiple buffered waveform tables 382A-D. It will be appreciated that more than four buffered waveform tables may be employed, with only four tables illustrated for clarity. One feature of this embodiment is that it allows each of the buffered waveform tables 382A-D to contain different sets of digital waveforms. For example, table 382A may contain output waveforms modulated to an arbitrary cable channel X, table 382B may contain waveforms for an arbitrary cable channel Y, and table 382C may contain waveforms for an arbitrary cable channel Z.

Controller 330 instructs a logical switch 384 to access the desired waveform, from one of the multiple buffered waveform tables 382A-D. For example, if output for cable channel Y is desired, the logical switch 384 is instructed to associate buffered data symbols stored in the “dictionary” of data symbols 370A-N with the appropriate waveform stored in one of the buffered waveform tables 382A-D.

Similar to the buffered output stage 315 illustrated in FIG. 6, the multiple-buffered output stage 375 receives digital data from one or more of the processors 276A-N. The data is received by the data partitioner 340 which partitions the data into blocks of data comprising input symbols. The resulting input symbol is written to a symbol register 350 where it is accessed by association logic 360 which matches the input symbol to a data symbol buffered in the data symbol “dictionary,” or table 370A-N. Once a match is made between the input symbol and a data symbol buffered in the data symbol table 370A-N, the appropriate buffered waveform table 382A-D, selected by the logical switch 384, is accessed and the stored digital waveform corresponding to the matched data symbol in data symbol table 370A-N is retrieved. The retrieved digital waveform is then passed to the output 203.

The digital waveforms stored in the both the buffered waveform tables 380A-N and the multiple buffered waveform tables 382A-D are equivalent to sampled versions of analog waveforms modulated to contain information provided by the input symbol. Using the look-up-table method employing buffered waveforms provided in this embodiment of the invention, the output 203 can comprise virtually any type of communication waveform.

In addition to providing digital synthesis of cable channel signals at the cable head-end, other aspects of the present invention provide communication capabilities employing ultra-wideband (UWB) technology for the cable head-end and for remote devices populating the cable television infrastructure.

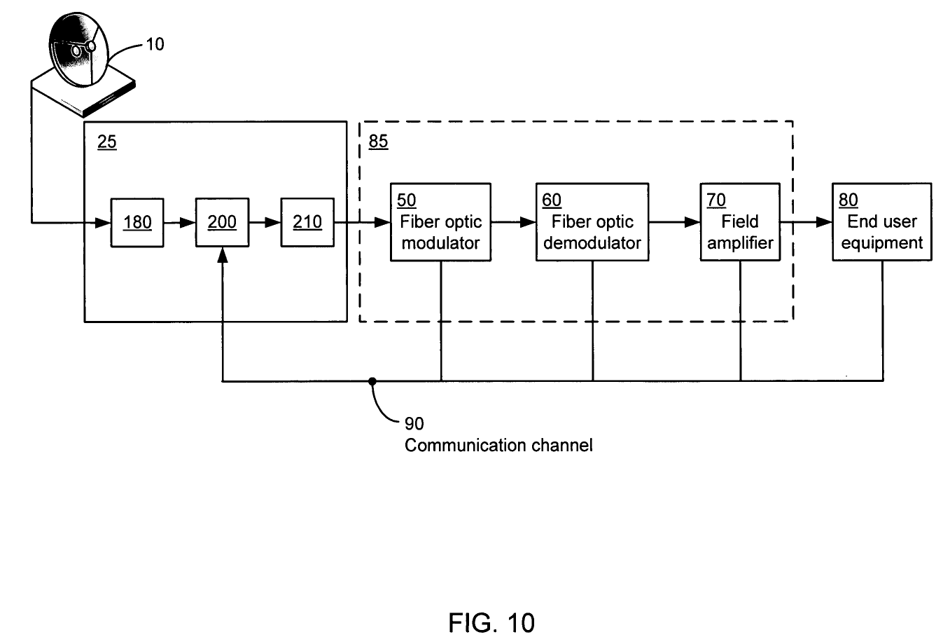

Referring now to FIGS. 1 and 10, in a hybrid fiber-coax system (HFCS), the combined broadband signal leaves the head-end 25 through fiber optic modulator 50 which transmits optical signals through fiber optic cable 55 for distribution into the field, such as residential neighborhoods, or business districts. Access nodes 85, which are located downstream of the head-end 25, receive the optical signal from the fiber, convert it to an RF signal and retransmit the RF signal on coax cable 45. Components that may be found in an access node 85 include fiber demodulators 60, filters (not shown), field amplifiers 70, as well as RF transmitters (not shown). The coax cable 45 distributes the signal to customers' end user equipment 80, such as TV's, set-top-boxes, cable modems, and other devices, such as wireless personal area network devices, wireless local area network devices, and wireless metropolitan area network devices. At the access node 85 the broadband signal is extracted from the fiber optic cable 55 and transferred to a coaxial cable 45 that connects to individual homes, apartments, businesses, universities, and other customers. In a HFCS, support of multiple customers is typically accomplished by the use of multiple access nodes 85, that may be located on telephone poles, underground, or at ground level. However, as the signal is continuously split at the access nodes 85, the quality of the signal is diminished, thereby diminishing the video, audio, and other data quality.

The digital channels that typically reside on cable television channels 79 and higher are fundamentally different than the analog channels that generally reside on channels 2 through 78. The analog channels comprise analog modulated carriers. The digital channels are digitally modulated using Quadrature Amplitude Modulation (QAM). QAM 16 transmits 4 bits per signal, QAM 32, 64, and 256 each transmit 5, 6 and 8 bits per symbol, respectively. HFCS networks usually employ QAM levels up to QAM 256 to enable up to multiple independent, substantially simultaneous MPEG video streams to be transmitted in a single 6 MHz channel allocation.

At the customer's location, the coaxial cable is connected to end-user equipment 80 typically comprising a device connected to a television, telephone, or computer. The end-user equipment 80 receives and de-modulates the RF signal conveying the video, audio, voice, Internet or other data. Although a television can directly receive the analog signal, a set-top box is generally required to receive the digitally encoded channels.

Communication systems employing coaxial cable 45 suffer from performance limitations caused by distance-related signal loss, signal interference, ambient noise, and spurious noise. These limitations affect the available system bandwidth, distance, and data carrying capacity of the system because the thermal noise floor and signal interference in the conductor (i.e., fiber optic and co-axial cables) overcome the transmitted signal. Moreover, noise within the network significantly limits the available bandwidth of the network. The conventional wisdom for overcoming this limitation is to boost the power (i.e., increase the voltage of the signal) at the transmitter to boost the voltage level of the signal relative to the noise at the receiver. Boosting the power at the transmitter helps enable the receiver to separate the noise from the desired signal. However, signal transmission power is typically limited to specified maximum levels, leaving the overall performance of coaxial cable systems still significantly limited by noise inherent in the system.

Maximizing the available bandwidth of an established cable network, while co-existing with the conventional data signals transmitted through the network, represents an opportunity to leverage the existing cable network infrastructure to enable delivery of greater functionality and additional services. Several methods and techniques have been proposed, but they generally require replacement of existing network components and are hence costly. However, exceptional increases in bandwidth, and thus HFCS, and other networks, functionality and capability may be realized through the use of ultra-wideband (UWB) communication methods.

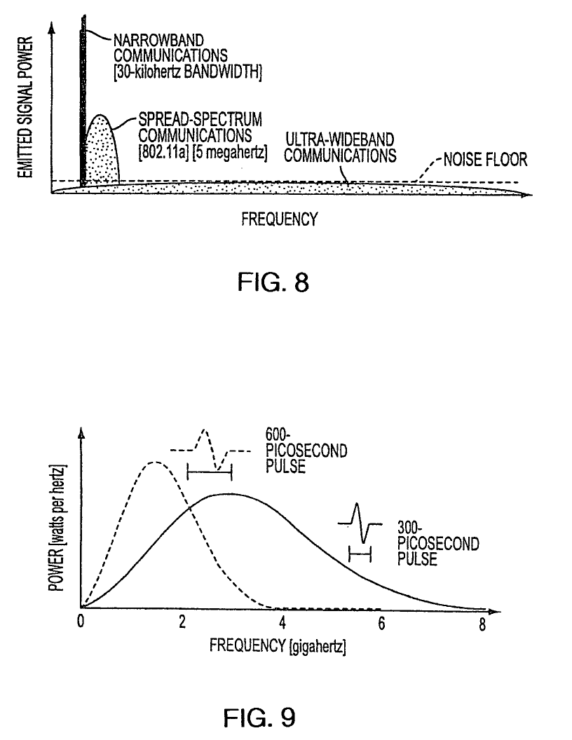

The embodiments of the present invention discussed below employ ultra-wideband communication technology. Referring to FIGS. 8 and 9, impulse-type ultra-wideband (UWB) communication employs discrete pulses of electromagnetic energy that are emitted at, for example, nanosecond or picosecond intervals (generally tens of picoseconds to hundreds of nanoseconds in duration). For this reason, this type of ultra-wideband is often called “impulse radio.” That is, the UWB pulses may be transmitted without modulation onto a sine wave, or a sinusoidal carrier, in contrast with conventional carrier wave communication technology. This type of UWB generally requires neither an assigned frequency nor a power amplifier.

An example of a conventional carrier wave communication technology is illustrated in FIG. 8. IEEE 802.11a is a wireless local area network (LAN) protocol, which transmits a sinusoidal radio frequency signal at a 5 GHz center frequency, with a radio frequency spread of about 5 MHz. As defined herein, a carrier wave is an electromagnetic wave of a specified frequency and amplitude that is emitted by a radio transmitter in order to carry information. The 802.11 protocol is an example of a carrier wave communication technology. The carrier wave comprises a substantially continuous sinusoidal waveform having a specific narrow radio frequency (5 MHz) that has a duration that may range from seconds to minutes.

In contrast, an ultra-wideband (UWB) pulse may have a 2.0 GHz center frequency, with a frequency spread of approximately 4 GHz, as shown in FIG. 9, which illustrates two typical UWB pulses. FIG. 9 illustrates that the shorter the UWB pulse in time, the broader the spread of its frequency spectrum. This is because bandwidth is inversely proportional to the time duration of the pulse. A 600-picosecond UWB pulse can have about a 1.8 GHz center frequency, with a frequency spread of approximately 1.6 GHz and a 300-picosecond UWB pulse can have about a 3 GHz center frequency, with a frequency spread of approximately 3.3 GHz. Thus, UWB pulses generally do not operate at a specific frequency, but rather over a extensive range of frequencies, as shown in FIG. 8. Either of the pulses shown in FIG. 9 may be frequency shifted, for example, by using heterodyning, to have essentially the same bandwidth but centered at any desired frequency. And because UWB pulses are spread across an extremely wide frequency range, UWB communication systems allow communications at very high data rates, such as 100's of megabits per second, 1 gigabit per second, or greater.

Several different methods of ultra-wideband (UWB) communications have been proposed. For wireless UWB communications in the United States, all of these methods must meet the constraints recently established by the Federal Communications Commission (FCC) in their Report and Order issued Apr. 22, 2002 (ET Docket 98-153). Currently, the FCC is allowing limited UWB communications, but as UWB systems are deployed, and additional experience with this new technology is gained, the FCC may revise its current limits and allow for expanded use of UWB communication technology.

The FCC April 22 Report and Order requires that UWB pulses, or signals occupy greater than 20% fractional bandwidth or 500 megahertz, whichever is smaller. Fractional bandwidth is defined as 2 times the difference between the high and low 10 dB cutoff frequencies divided by the sum of the high and low 10 dB cutoff frequencies. Specifically, the fractional bandwidth equation is:

$$Fractional Bandwidth = 2 \frac{{f}_{h} - {f}_{l}}{{f}_{h} + {f}_{l}}$$

where fₕ is the high 10 dB cutoff frequency, and fₗ is the low 10 dB cutoff frequency.

Stated differently, fractional bandwidth is the percentage of a signal's center frequency that the signal occupies. For example, a signal having a center frequency of 10 MHz, and a bandwidth of 2 MHz (i.e., from 9 to 11 MHz), has a 20% fractional bandwidth. That is, center frequency, f_{c}=(fₕ+fₗ)/2

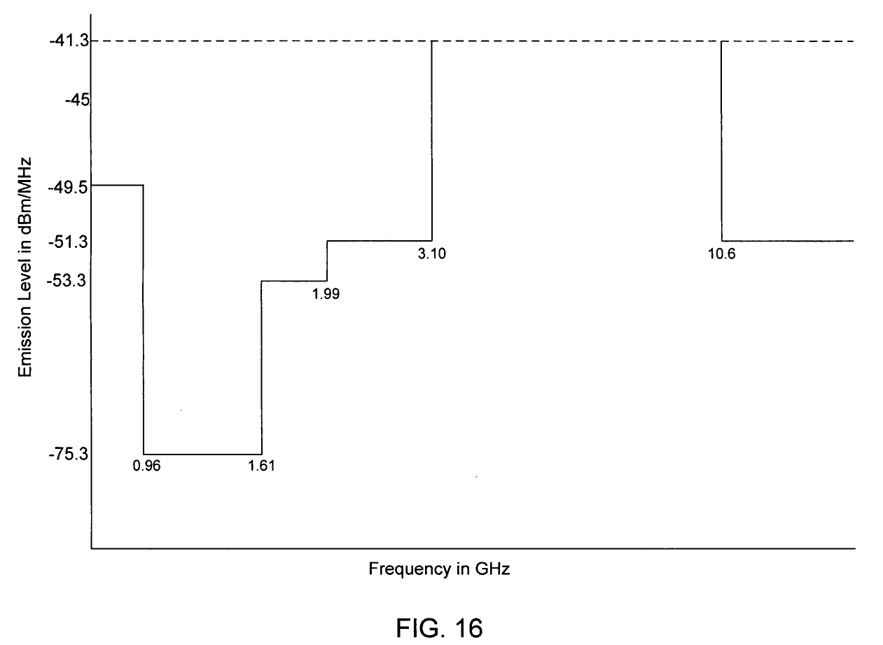

FIG. 16 illustrates the ultra-wideband emission limits for indoor systems mandated by the April 22 Report and Order. The Report and Order constrains UWB communications to the frequency spectrum between 3.1 GHz and 10.6 GHz, with intentional emissions to not exceed −41.3 dBm/MHz. The report and order also established emission limits for hand-held UWB systems, vehicular radar systems, medical imaging systems, surveillance systems, through-wall imaging systems, ground penetrating radar and other UWB systems. It will be appreciated that the invention described herein may be employed indoors, and/or outdoors, and may be fixed, and/or mobile, and may employ either a wireless or wire media for a communication channel.

Generally, in the case of wireless communications, a multiplicity of UWB pulses may be transmitted at relatively low power density (milliwatts per megahertz). However, an alternative UWB communication system, located outside the United States, may transmit at a higher power density. For example, UWB pulses may be transmitted between 30 dBm to −50 dBm.

Generally, UWB pulses, however, transmitted through many wire media will not interfere with wireless radio frequency transmissions. Therefore, the power (sampled at a single frequency) of UWB pulses transmitted though wire media may range from about +30 dBm to about −140 dBm. The FCC's April 22 Report and Order does not apply to communications through wire media.

Communication standards committees associated with the International Institute of Electrical and Electronics Engineers (IEEE) are considering a number of ultra-wideband (UWB) wireless communication methods that meet the constraints established by the FCC. One UWB communication method may transmit UWB pulses that occupy 500 MHz bands within the 7.5 GHz FCC allocation (from 3.1 GHz to 10.6 GHz). In one embodiment of this communication method, UWB pulses have about a 2-nanosecond duration, which corresponds to about a 500 MHz bandwidth. The center frequency of the UWB pulses can be varied to place them wherever desired within the 7.5 GHz allocation. In another embodiment of this communication method, an Inverse Fast Fourier Transform (IFFT) is performed on parallel data to produce 122 carriers, each approximately 4.125 MHz wide. In this embodiment, also known as Orthogonal Frequency Division Multiplexing (OFDM), the resultant UWB pulse, or signal is approximately 506 MHz wide, and has approximately 242-nanosecond duration. It meets the FCC rules for UWB communications because it is an aggregation of many relatively narrow band carriers rather than because of the duration of each pulse.

Another UWB communication method being evaluated by the IEEE standards committees comprises transmitting discrete UWB pulses that occupy greater than 500 MHz of frequency spectrum. For example, in one embodiment of this communication method, UWB pulse durations may vary from 2 nanoseconds, which occupies about 500 MHz, to about 133 picoseconds, which occupies about 7.5 GHz of bandwidth. That is, a single UWB pulse may occupy substantially all of the entire allocation for communications (from 3.1 GHz to 10.6 GHz).

Yet another UWB communication method being evaluated by the IEEE standards committees comprises transmitting a sequence of pulses that may be approximately 0.7 nanoseconds or less in duration, and at a chipping rate of approximately 1.4 giga pulses per second. The pulses are modulated using a Direct-Sequence modulation technique, and is called DS-UWB. Operation in two bands is contemplated, with one band is centered near 4 GHz with a 1.4 GHz wide signal, while the second band is centered near 8 GHz, with a 2.8 GHz wide UWB signal. Operation may occur at either or both of the UWB bands. Data rates between about 28 Megabits/second to as much as 1,320 Megabits/second are contemplated.

Another method of UWB communications comprises transmitting a modulated continuous carrier wave where the frequency occupied by the transmitted signal occupies more than the required 20 percent fractional bandwidth. In this method the continuous carrier wave may be modulated in a time period that creates the frequency band occupancy. For example, if a 4 GHz carrier is modulated using binary phase shift keying (BPSK) with data time periods of 750 picoseconds, the resultant signal may occupy 1.3 GHz of bandwidth around a center frequency of 4 GHz. In this example, the fractional bandwidth is approximately 32.5%. This signal would be considered UWB under the FCC regulation discussed above.

Thus, described above are four different methods of ultra-wideband (UWB) communication. It will be appreciated that the present invention may be employed by any of the above-described UWB methods, or others yet to be developed.

One feature of UWB is that it may transmit a signal with a power spectral density that is generally evenly spread over the entire bandwidth occupied by the signal. As discussed above, HFCS cable channels typically use AM or QAM modulation, although other modulation methods may be employed. Due to the very spread power spectral density of UWB, at the HFCS cable channel frequencies, the UWB signal's power is well below the minimum power detected by the HFCS system. Thus, UWB signals do not interfere with the demodulation and recovery of the original AM or QAM data signals. UWB technology thus makes use of the dynamic range of the channel to transmit data, without interfering with the carrier signals. Moreover, given the high data rates possible with UWB technology, injecting UWB signals into the outgoing RF stream at the head-end 25 of a cable television network adds substantially greater information bandwidth to the system without interfering with existing, conventional cable channel content.

In addition to providing digital synthesis of cable channel signals at the cable head-end 25, as discussed above, other embodiments of the present invention provide communication capabilities employing ultra-wideband (UWB) technology for the cable head-end 25 and for remote devices populating the cable television infrastructure. This aspect of the present invention provides methods enabling communications between the cable head-end 25 and remote cable television system components such as fiber-optic modulators 50 or de-modulators 60, field amplifiers 70, access nodes 85 and end-user equipment 80.

Referring now to FIG. 10, further embodiments of the present invention provide for a full duplex communication scheme including an “upstream” channel employing UWB technology, and conventional communication methods. One feature of this upstream channel is that it enables communication from cable television infrastructure components (such as fiber-optic modulators 50, end-user equipment 80, and access nodes 85 containing de-modulators 60, field amplifiers 70, and splitters (not shown)) to the cable head-end 25. Corresponding “downstream” communications from the cable head-end 25 and cable television infrastructure components may be similarly accomplished using UWB or conventional methods over the downstream channels.

As shown in FIG. 10, end user equipment 80 and access node devices 85, which may include filters, RF transmitters (not shown), fiber optic modulators 50, de-modulators 60, and field amplifiers 70, may perform several functions, such as: responding to status queries from the cable head-end 25; providing autonomous status reports at various times; and providing autonomous status reports when some exception, error, out-of-tolerance condition, or failure has occurred. Additionally, the head-end 25 may set an alert condition when an out-of-tolerance message is received from the access node devices 85. As shown in FIG. 10, the access node devices 85 may include some, all, or additional devices not illustrated. For example, a fiber optic modulator 50 is required in or near the head end 25, to receive and modulate the channel signals onto the fiber optic cable that is used to distribute the channel signals. At an access node, a fiber optic demodulator 60 demodulates the channel signals, and transfers them to a co-axial cable. However, “upstream” signals may need to be sent to the head end 25. Thus, the access node may also include a fiber optic modulator 50, which modulates the “upstream” signal and sends it up the fiber optic cable to the head end 25.

Many cable television access node devices 85 require periodic maintenance checks which are usually accomplished by a technician traveling to the site of the component to monitor, test and perform a physical inspection. Moreover, many functioning access node devices 85 are replaced as a matter of procedure to mitigate the likelihood of failure and consequent network unavailability. Aspects of the present invention that communicate status information between the cable head-end 25 and access node devices 85 enable more efficient and cost-effective maintenance procedures. For example, an access node device 85 may be replaced when reports from the access node device 85 indicates an error or a failure mode, instead of requiring prophylactic replacement according to a fixed maintenance schedule. One feature of this aspect of the invention is that each access device 85 may include an individual, or specific address, or identifier, that allows each access device 85 to be individually identified and/or controlled.

One feature of the present invention includes optimization of network parameters in real-time. For example, status reports from access node devices 85 and/or end user equipment 80 may contain environmental and network performance measurements, including, for example, per-channel signal strengths. In that instance, the cable head-end 25 may adjust the signal transmission power of a channel in order to maximize its Carrier-to-Noise Ratio (CNR) according to specified upper and lower limits, while possibly also simultaneously optimizing the dynamic range of the region lying below the range of the channel content and extending still lower to the thermal noise level of the cable television conductors. The upper and lower dynamic ranges may therefore be adjusted and optimized in real-time according to signal power measurements fed back from the access node devices 85 and/or end user equipment 80. This capability maintains optimal conditions for signal transmission in the network, improving network performance. In one embodiment, these, and other network parameters may be optimized for UWB communications. In addition, status information relating to one, or more of the access node devices 85 may be transmitted to the head-end 25. For example, status information may include an access node device 85 temperature, power consumption, saturation condition, frequency response, and other information of interest.

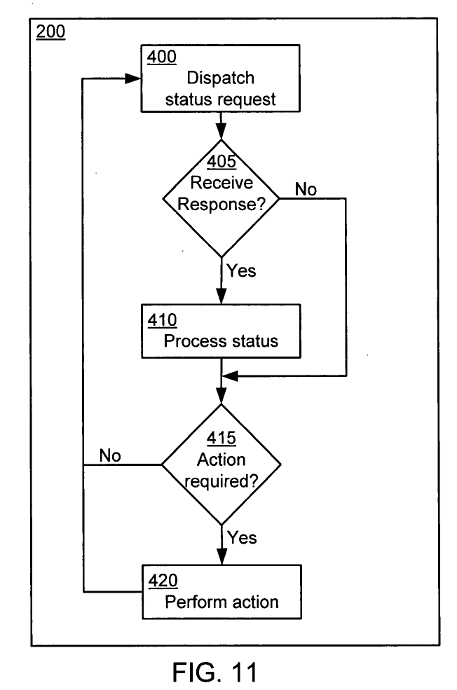

As shown in FIG. 10, a communication channel 90 is provided that enables “upstream” communications from access node devices 85 to the cable head-end 25, and “downstream” from the cable head-end 25 to the access node devices 85 and/or end-user equipment 80. In one embodiment of the invention, illustrated in FIG. 11, the processing module 200 of the cable head-end 25 dispatches a status request message in step 400 downstream over the communications channel 90 to an access node device 85 and/or to end-user equipment 80. The access node device 85 and/or the end-user equipment 80 then formulates a status response message and dispatches the response message upstream over the communications channel 90 to the processing unit 200 at the head-end 25. The processing module 200 tests to determine if a response has been received in step 405. If a response has been received, the network status information is processed in step 410 and a determination made, in step 415, as to whether a responsive action is required. If an action is not required, processing returns to the first step 400 to dispatch a new status request message. If an action is required, however, the action is performed in step 420 at the head-end 25 before returning to the first step to dispatch a new status request 400. Actions performed in step 420 may include logging maintenance or component health information, notifying maintenance personnel of the health, or lack thereof, of any access node devices 85 and/or any end-user equipment 80, dispatching information downstream to any access node devices 85 and/or to any end-user equipment 80, and effecting a control response according to information included in the status report. It will be appreciated that the step of dispatching status request messages 400 may be accomplished on a one-by-one basis to individual access node devices 85 and/or to individual end-user equipment 80 or “broadcast” to more than one device on the network.

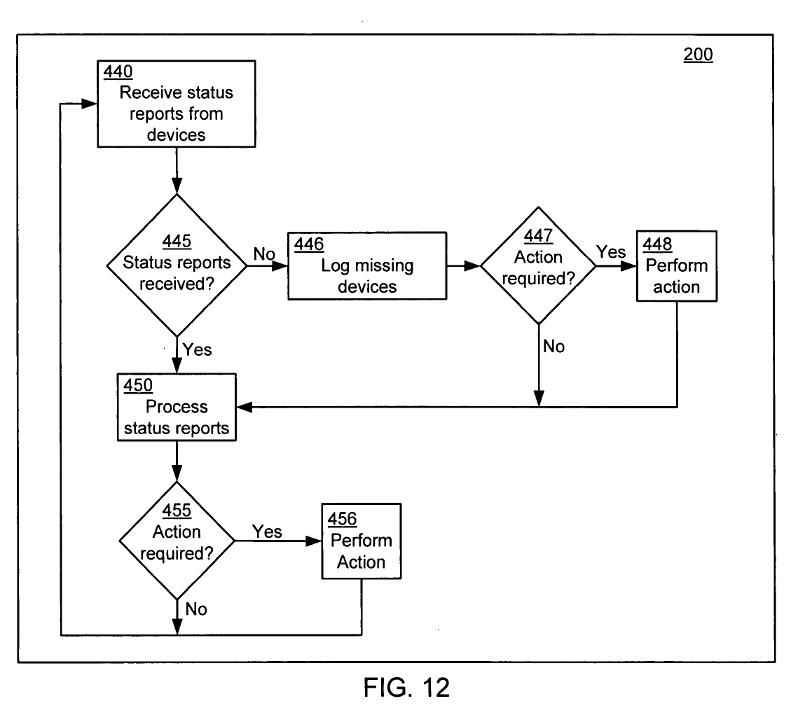

In one method of the present invention, access node devices 85 and/or end-user equipment 80 autonomously dispatch status messages to the processing module 200 at the cable head-end 25, eliminating the need for the processing module 200 to dispatch status requests. As shown in FIG. 12, in step 440, the processing module 200 receives status reports from all, or some of, the access node devices 85 and/or end-user equipment 80 on the network. In step 445, a check is performed to determine whether any status messages from devices of interest have actually been received. If no status reports are determined as missing, the received status reports are evaluated in step 450. If status reports are determined as missing, the identities or addresses of the access node devices 85 and/or end-user equipment 80 that did not report may be logged in step 446. A test is performed in step 447 to determine if an action at the head-end 25 by the processing module 200 is required. If so, the action is performed in step 448. The actions that may be performed in step 448 include but are not limited to: logging maintenance of access node devices 85 and/or end-user equipment 80 health information; notifying maintenance personnel of access node devices 85 and/or end-user equipment 80 health indications; dispatching information downstream to the access node devices 85 and/or end-user equipment 80; and effecting a control response according to information included in the status report from the access node devices 85 and/or end-user equipment 80. If no action is required, then the status reports received from are evaluated in step 450. A test is performed in step 455 to determine whether any actions at the head-end by the processing module 200 are required in response to the status report evaluations of step 450. If no actions are required, then the process returns to the initial step 440 of receiving status reports. If one or more actions are required, those actions are performed in step 456 before the process returns to the initial step 440 of receiving status reports. The actions performed may include: logging maintenance of access node devices 85 and/or end-user equipment 80 health information; notifying maintenance personnel of access node devices 85 and/or end-user equipment 80 health indications; dispatching information downstream to the access node devices 85 and/or end-user equipment 80; effecting a control response according to information included in the status report from the access node devices 85 and/or end-user equipment 80; and setting an alert condition at head-end 25.

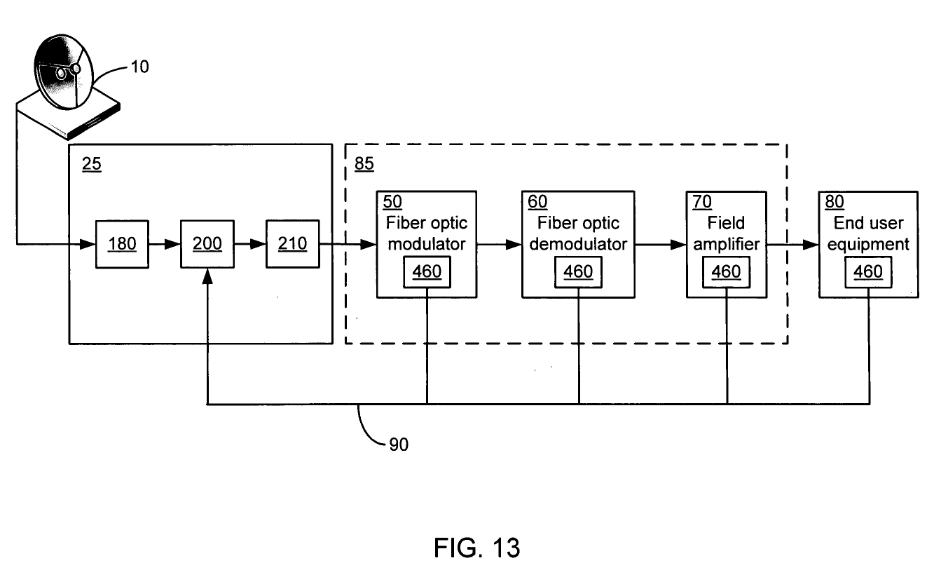

One embodiment of the present invention provides a method for controlling cable system, or network performance parameters from the cable head-end 25 according to information communicated by access node devices 85 and/or end-user equipment 80. Referring to FIG. 13, cable television system access node devices 85, such as fiber optic modulators 50, and de-modulators 60, field amplifiers 70, and end-user equipment 80 may include a sensor 460, or the functional equivalent of a sensor 460, capable of measuring one or more environmental or cable system performance parameters. Information obtained form the sensors 460 may be communicated to the head-end 25. For example, the sensor 460 on field amplifier 70 may measure the high and/or low cable signal power levels on the various channels. Communicating measurements of these power levels over the communication channel 90 to the cable head-end 25 may thus enable corrective adjustments at the head-end 25 to tailor the signal so that the signal transmission power levels lie within desired tolerances as measured at the field amplifier 70.

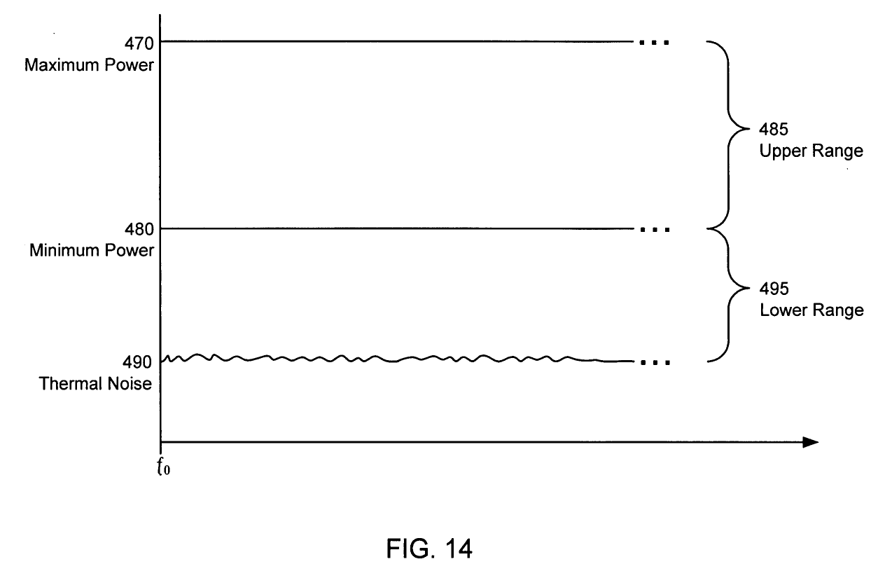

One feature of the present invention is that it allows for management of bandwidth and signal power conditions in a cable television architecture. As shown in FIG. 14, transmission power requirements for conventional, relatively narrow-band communications are typically constrained to lie within an upper range 485 defined by specified maximum 470 and minimum 480 signal power levels. A lower range 495 is defined as that below the upper range 485 and above the thermal noise power level 490. The lower range 495 is typically not used for conventional channel communications, but is useful for UWB communications signals. Real-time feedback from access node devices 85 and/or end-user equipment 80 would enable control mechanisms at the head-end 25 to maintain signal power levels in the optimal ranges for specific frequencies.

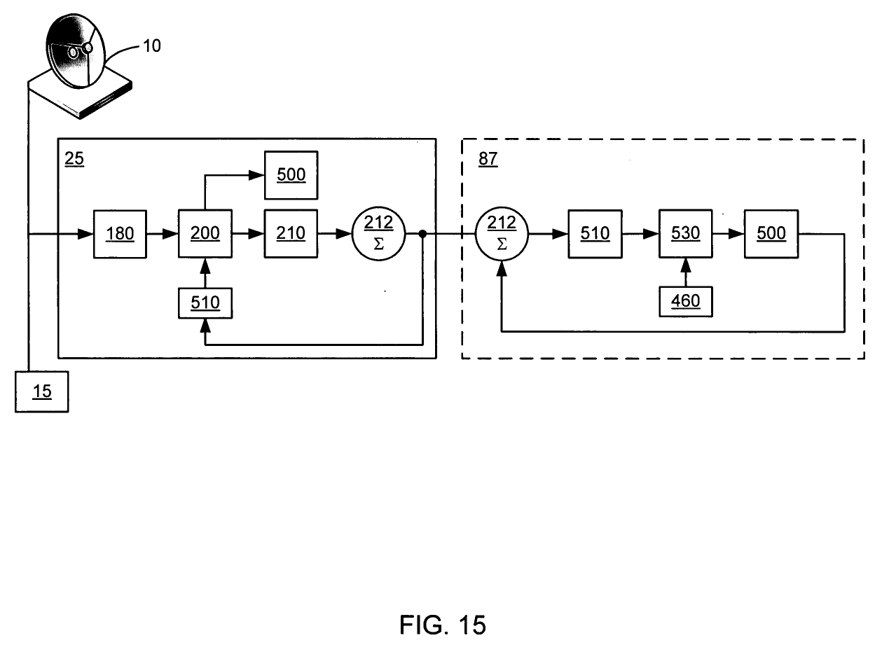

Another embodiment of the present invention enables ultra-wideband (UWB) communication signals to be transmitted through the cable network. Shown in FIG. 15, the cable head-end 25 generates a conventional radio frequency (RF) signal that is transmitted through the cable network. Though a cable network typically comprises a plurality of access node devices 85 and end-user equipment 80 components, a single representative device 87 is shown in FIG. 15. For example, the single representative device 87 may comprise fiber optic modulators 50, and de-modulators 60, field amplifiers 70, and end-user equipment 80.

As discussed above, the RF signal is typically passed to the cable head-end 25 from satellite antennas 10 and local sources 15. According to one embodiment of the present invention, the RF signal is then passed to the ADC 180, which produces a digitized equivalent signal. The digitized signal is conveyed to the processing module 200 for general processing, usually comprising signal conditioning steps and conversion to appropriate output cable channels, as discussed above. From the processing module 200, the digital composite cable signal is passed to a DAC 210 for conversion into an RF signal.

According to an embodiment of the invention, tasks performed by the processing module 200 also include formulating messages containing information for one or more devices 87 on the cable network. The messages are encoded by the processing module 200 and routed to an UWB modulator 500, which converts the encoded message into an UWB signal. The UWB signal is combined with the signal generated by DAC 210 in a way as to not interfere with the reception of the conventional signals, by UWB summer 212. Alternatively, the UWB data may be combined with the conventionally modulated data prior to conversion to an analog signal by DAC 210. The UWB waveforms may then be transmitted through the cable network. At the remote device 87, the cable signal is received and passed to an UWB demodulator 510. The UWB demodulator 510 demodulates the UWB signals to recover the encoded message conveyed by the UWB signals. The encoded message is next passed to a UWB processing module 530 that decodes the message and processes the information. The UWB processing module 530 may then formulate a response to the received message. The UWB processing module 530 may also receive environmental and network parameter measurements from a local sensor device 460 in addition to the encoded message from the demodulator 510. For example, according to one embodiment of the invention, the sensor device 460 measures received channel signal power levels. Response information and sensor measurements, if any, are encoded by the UWB processing module 530 into a response message and passed to an UWB modulator 500. The modulated UWB waveforms are then combined with other upstream signals, if present, by a UWB combiner 212. At the head-end 25 the signal routed to an UWB demodulator 510. The demodulator 510 demodulates the signals to recover the encoded message from the device 87. The encoded message is next passed to the head-end 25 processing module 200 to decode the message and processes the information.

Under this communications scheme, UWB messages are “broadcast” onto the cable network, thus creating a potential problem. That is, without corrective action, any device on the network could potentially receive and process messages not destined for it, including those messages the device itself has sent to one or more other devices. In one embodiment of the invention, this problem is addressed by encoding into each transmitted message a unique device identification (ID) or address specifying “to” which device the message is destined and another ID indicating “from” which device the message originated. Each device may then reject any messages not containing its ID as a destination address. Referring to FIG. 15, the head-end 25 processing module 200 and UWB processing module 530 are therefore precluded from responding to their own transmitted UWB messages, or to messages not destined to them.

Referring again to FIG. 15, which illustrates another method of the present invention. The cable head-end 25 may query access node devices 85 and/or end-user equipment 80 on the cable network for various types of status information. In this method, a status request is encoded by the processing module 200 at the cable head-end 25, the encoded message is then sent to UWB modulator 500, and sent to combiner 212 where it is combined with the cable channel stream and transmitted onto the cable network. A cable network device 87 then receives the RF cable channel stream. The UWB signals are demodulated by UWB demodulator 510 and the encoded message is passed to the UWB processing module 530 for decoding. The UWB processing module 530 processes the information contained in the request, and formulates a status response as needed. Information received from a sensor 460 may also be incorporated into the response. In one embodiment of the invention, the sensor information may comprise channel power level measurements. The status response is then encoded by UWB processing module 530. The status response is next sent to UWB modulator 500, and combined with other upstream signals, if any, in combiner 212 for upstream transmission.

At the head-end 25, a copy of the signal is routed to an UWB demodulator 510. The encoded status response recovered by UWB demodulator 510 is passed to the processing module 200. The processing module 200 performs tasks to determine the status of the cable network device 87 and, in one embodiment of the invention, analyzes the channel power level measurements included in the status response. The power level measurements for one or more channels may therefore be used to determine whether actual channel power levels are within specified tolerances. Referring to FIG. 14, maximum 470 and minimum 480 power levels define an optimal operating range, or upper range 485 for conventional channel content. This simultaneously ensures that the lower power range 495 is available for UWB communications.

In one embodiment of the invention, the signal energy of the UWB data stream is spread across a bandwidth that may range from about 50 MHz to approximately 870 MHz, 1 GHz, or higher. Referring to FIG. 14, this ensures that the signal energy present at any frequency is significantly below the upper power range 485 of existing, conventional RF cable carrier signals and above the thermal noise floor 490 of the cable conductor.

For example, if the power levels on a particular channel do not exceed the lower bound 480, the processing module may responsively adjust the power levels to optimal levels during the digital synthesis of the signal, as described above. Alternatively the head-end 25 may set an alert notifying cable plant personnel of an out-of-tolerance condition. Thus, real-time analysis of communication channel power levels may provided by the methods disclosed by this embodiment of the invention.

It will be appreciated that the UWB modulator 500 and UWB demodulator 510, illustrated in FIG. 15, may include some or all of several components, including a controller, a digital signal processor, an analog coder/decoder, one or more devices for data access management, and associated cabling and electronics. The controller may include error control and data compression functions. The analog coder/decoder may include an analog to digital conversion function and vice versa. The data access management device or devices may include various interface functions for interfacing to wired media such as phone lines and coaxial cables. Additionally, these devices may employ communications technologies other than UWB for communicating status and other types of information. Accordingly, the invention is not limited with respect which type of RF communications transport messages to and from head-end 25 to cable network devices 87.

Thus, it is seen that apparatus' and methods for digitally synthesizing cable television channel data, transmitting and receiving status reports from remote network devices, and transmitting and receiving UWB signals through a cable television network are provided. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

What is claimed is:

1. A buffer apparatus, comprising:
a signal input structured to receive a communication signal;
a data symbol library communicating with the signal input, the data symbol library structured to match the communication signal with a stored data symbol;
a first radio frequency waveform library communicating with the data symbol library, the first radio frequency waveform library structured to match the stored data symbol with a stored digital radio frequency waveform;
a digital to analog converter (DAC), communicating with the first radio frequency waveform library, the DAC structured to convert the digital radio frequency waveform to an analog signal.

2. The apparatus of claim 1, further comprising:
a second radio frequency waveform library communicating with the data symbol library, the second radio frequency waveform library structured to match the stored data symbol with a stored digital radio frequency waveform.

3. The apparatus of claim 1, wherein the first radio frequency waveform library comprises a list containing a plurality of radio frequency waveforms that correspond to a first data modulation method.

4. The apparatus of claim 2, wherein the second radio frequency waveform library comprises a list containing a plurality of radio frequency waveforms that correspond to a second data modulation method.

5. The apparatus of claim 1, wherein the step of converting the digital radio frequency waveform into an analog radio frequency waveform employs a digital to analog converter that can sample the digital radio frequency waveform at at least twice the inverse of a highest frequency component of the digital radio frequency waveform.

6. The apparatus of claim 1, where the communication signal is selected from a group consisting of: a video signal, an audio signal, an Internet-formatted signal, an Ethernet-formatted signal, an NTSC-formatted signal, an MPEG-formatted signal, and a JPEG-formatted signal.

7. The apparatus of claim 1, where the data symbol library comprises a list containing a plurality of symbols.

8. The apparatus of claim 1, where the first radio frequency waveform library comprises a list containing a plurality of radio frequency waveforms.

9. A method of supplying data to a digital to analog converter (DAC), the method comprising the steps of:
providing a data symbol;
matching the data symbol with a stored data symbol;
matching the stored data symbol with a digital radio frequency waveform; and
passing the digital radio frequency waveform to the DAC.

10. The method of claim 9, further comprising the step of:
converting the digital radio frequency waveform into an analog radio frequency waveform.

11. The method of claim 10, wherein the step of converting the digital radio frequency waveform into an analog radio frequency waveform comprises:
sampling the digital radio frequency waveform at at least twice the inverse of a highest frequency component of the digital radio frequency waveform.

12. The method of claim 10, wherein the step of matching the data symbol with a stored data symbol comprises obtaining a data symbol from a data symbol memory.

13. The method of claim 10, wherein the step of matching the stored data symbol with a digital radio frequency waveform comprises obtaining a digital radio frequency waveform from a digital radio frequency waveform memory.

14. A method of supplying data to a digital to analog converter (DAC), comprising:
means for providing a data symbol;
means for matching the data symbol with a stored data symbol;
means for matching the stored data symbol with a digital radio frequency waveform; and
means for passing the digital radio frequency waveform to the DAC.

15. The method of claim 14, further comprising:
means for converting the digital radio frequency waveform into an analog radio frequency waveform.

16. The method of claim 15, wherein the means for converting the digital radio frequency waveform into an analog radio frequency waveform comprises:
means for sampling the digital radio frequency waveform at at least twice the inverse of a highest frequency component of the digital radio frequency waveform.

17. The method of claim 14, wherein the means for matching the data symbol with a stored data symbol comprises obtaining a data symbol from a data symbol memory.

18. The method of claim 10, wherein the means for matching the stored data symbol with a digital radio frequency waveform comprises obtaining a digital radio frequency waveform from a digital radio frequency waveform memory.
